(19) United States
(12) Patent Application Publication
(10) Pub. No.: US 2007/0005394 A1
(43) Pub. Date: Jan. 4, 2007

(54) Method and apparatus for managing medical order sets

(75) Inventors: Piet Bleyendaal, Wellesley, MA (US); Peter Bonis, Wellesley, MA (US)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Up ToDate Inc., Waltham, MA (US)

(21) Appl. No.: 11/448,307

(22) Filed: Jun. 7, 2006

Related U.S. Application Data
(60) Provisional application No. 60/688,258, filed on Jun. 7, 2005.

(51) Int. Cl. G06Q 10/00

(52) U.S. Cl. 705/2

(57) ABSTRACT

A system and method for maintaining medical order sets allows for a medical information resource provider to generate and make available order sets for use in providing medical care. Subscribers to the order sets may modify the order sets, and may receive notification when changes to the order sets and/or changes to content in the medical information resource that are relevant to the order sets occur. Subscriber-created and/or provider-created associations between order sets and content in the medical information resource may be used to identify the need to provide a notification when changes to content occur.

This application claims the benefit of U.S. Provisional application No. 60/688,258, filed Jun. 7, 2005.

### BACKGROUND

1. Field of Invention

This invention relates to methods and systems for managing medical order sets, e.g., information sets for administering medical care for one or more patients.

2. Related Art

To encourage the provision of care that meets established standards, hospitals often develop checklists for physicians and others to follow for the management of common medical conditions. These checklists are known as order sets. (Herein, the term “order set” refers to order sets as well as order rules, to the extent there is a difference between the two.) Order sets generally provide an algorithmic, condition-specific approach to management, instructing medical professionals as to the tasks they should perform, often in a particular order, such as from admission through lab work, monitoring, medication, patient counseling, and related tasks.

For example, an order set for an acute myocardial infarction admission may include list items to check, date, and initial for admission, including vital signs, cardiologist consultation, notification of relevant personnel, vital sign monitoring, administration of medications such as heparin and nitroglycerin, establishment of particular dietary restrictions during the hospital stay, and patient counseling on such issues as smoking cessation. Such an order set may contain 20 or more checklist items and/or decision trees (generally referred to herein as “tasks”), some of which may contain 5-10 sub-items. Without these checklists, it may be difficult for hospitals to ensure that each medical practitioner performs the full list of tasks that is agreed to be the appropriate course of management for a particular condition.

### SUMMARY OF INVENTION

Typically, order sets are established by committees (at larger hospitals) or by specialists (at smaller hospitals) in order to ensure that the care provided by hospital personnel meets current guidelines and best practices established by the medical community and by medical societies, using the latest evidence from research and practice. However, it has been appreciated by the inventors that it may be difficult to ensure that the latest medical developments are reflected in the order sets, and that changes relevant to order sets are communicated adequately to users as medical developments occur. For example, hospitals may build and maintain order sets in an ad hoc fashion and at great expense. In one case, a hospital system has created a list of over 200 order sets on the Internet, requiring an enormous investment of time and expertise to create and maintain. In one case, a review of 202 patient encounters at a medical center revealed that a total of 115 distinct order sets were used, and that these order sets were used in 79% of admissions, with 49% of admissions using more than one order set. Of those order sets, 27% were more than one year old, and 44% were undated. This study, together with anecdotal evidence, suggests that order sets may be used very frequently, at least in some environments. In addition, order sets may not necessarily be updated to reflect the most current standards of care. Also, order sets may be variable by hospital, depending upon the available facilities, local capabilities, and varying interpretation of available research.

In one aspect of the invention, a computer database of generic order sets may be generated by a single provider, and the order sets may be based on the latest available research, and on recommendations made by medical societies and other members of the medical community. The provider may be a provider of medical information resource, such as an online store of medical articles, clinical recommendations, and other health care-related content. The provider may be particularly well suited to generating and maintaining such order sets, given the provider's intimate involvement with reviewing, compiling and otherwise managing clinical information used by health care providers. Making the database of order sets available to hospitals and other health care providers may reduce the duplication of effort required for each entity to create its own order sets, as well as ensure that order sets are kept up to date.

In another aspect of the invention, a method for providing medical-related information includes producing computer-useable data regarding a plurality of medical care order sets. Each of the order sets may include, among other optional items, a plurality of tasks to be performed in administering medical care for a patient, such as treatment regimens, medications to be provided, instructions for complying with certain quality measures, instructions for billing accuracy, etc. The computer-useable data may be provided in any suitable form, such as a database record (or records, e.g., in the case of a relational database), one or more text files, one or more XML files, and so on. The data regarding the order sets may be produced by a medical information service, such as an Internet-based provider of other medical information. At least one subscriber may be associated with one or more order sets in the plurality of order sets, e.g., a hospital or other health care provider may choose to subscribe to one or more order sets for use in providing medical care. The subscriber may be provided, via a computer network such as the Internet or other suitable arrangement, information regarding the order set(s). Thereafter, the subscriber may use the order set(s) as it sees fit, e.g., by implementing the order sets in the form provided, and/or with some subscriber-specific modifications being made to the order set. For example, the subscriber may incorporate the order sets into patient electronic medical records, using the tasks in the order set to create checklists and forms used by medical personnel.

In one embodiment, the order set provider may make a change to the subscriber's order set(s) based on new medical information that is judged to warrant the change. The change to the order set(s) may have differing levels of impact on the order set, and may require no, little, or major changes in the way in which medical care is provided. Notification may be provided to the subscriber via the computer network of the change to the order set(s). For example, the subscriber may be sent an email notice that indicates that changes have been made to one or more order sets, and that the subscriber may wish to review the order sets in question and determine whether a change in practice or procedure should be made. In another embodiment, the subscriber may be sent computer-useable data that represents a replacement order set for those order sets including a change. The change may be highlighted or otherwise marked so that the subscriber can readily determine the nature of the change to the order set. Changes may also be electronically propagated into subscriber order sets and/or electronic medical records. Other information may be provided, such as links to supporting data that prompted the change, reasons for and/or potential effects of the change, and so on.

In one embodiment, the provider of order set information may receive, via the computer network, information from the at least one subscriber regarding subscriber-made changes to one or more order sets. Thus, the subscriber may use the generic order sets from the provider as a template, and modify the order sets in any suitable way to customize the order sets for use by the subscriber. However, the subscriber may indicate what changes were made to the order sets, e.g., to allow the provider that originally generated the order set to determine whether changes to the subscriber-modified portions of the order set may be warranted in response to advances or new findings in a related medical field. If so, the order set provider may provide notification to the subscriber of the suggested changes.

In another embodiment, one or more portions of an order set may be associated with content in a medical information resource, such as that maintained by the order set provider. Associations between a portion of an order set and content may be based on a selected topic, a defined section of the content, a keyword in the content, or a graphical depiction in the content. For example, a portion of an order set relating to the administration of a drug may be associated with one or more articles in a computerized medical information resource regarding the drug. This association may allow a user of the order set to readily access the associated articles for review and/or allow the subscriber to be notified of changes to the articles that may impact clinical procedure related to the order set. The association between the portion of the order set and the content may be apparent to users of the order set, e.g., order set forms may include electronic links (e.g., a URL or other) or other indications of the associated content, or may normally be hidden from a user. Hidden associations may be useful for identifying portions of order sets that may be affected when changes to the content in a medical information resource are made.

In another aspect of the invention, a method for providing medical-related information includes providing information regarding a medical order set. The information may be provided by a subscriber/user of the order set and/or an order set provider (e.g., a provider of medical information resources), and may be in a computer-useable form, such as a computer database or other file. A computer-useable record may be generated that includes information regarding an association of a subscriber of a computerized medical information resource with the order set, and an association of a portion of the order set with content in the computerized medical information resource. For example, a subscriber to the medical information resource may complete a computer-generated record so as to identify an association of a portion of an order set with content in the medical information resource. In one embodiment, the computer-useable record may include information regarding a date of the association, a responsible party at the subscriber, an importance of the association of the portion of the order set with the content, a memo field, a reference to the portion of the order set, and/or a reference to a portion of the medical information resource.

The record may allow the subscriber to access content in the medical information resource that impacts the portion of the order set, as needed. For example, the subscriber may associate a portion of an order set regarding the administration of a cancer treatment drug to content in the medical information resource that relates to the drug, relates to cancer treatment in general, and/or relates to delivery techniques for the drug. Based on this association, users of the order set that have questions regarding the drug and its use can identify the association, and readily access relevant content. In addition, or alternately, the association may allow the medical resource information provider to notify the subscriber (and its user(s)) of changes in the content related to the association. Thus, for example, if recent studies have found that a particular delivery method for the cancer treatment drug produces significantly improved results, the content may be correspondingly updated, and the subscriber may be notified of the change in content and its potential effect on use of the associated order set.

In another embodiment, the computer-usable record may be used by a subscriber to subscribe to order sets based on identified content. For example, a subscriber may complete the record, identifying portions of content in the medical information resource for which the subscriber would like to receive order set information. The provider of the medical information resource may automatically identify which order set(s) are associated with the content selected by the subscriber, and may provide the order set information to the subscriber, e.g., by computer network.

In one embodiment, computer-useable data regarding a topic card may be provided to a subscriber. The topic card information may correspond to one or more order sets, and may include a clinical purpose for the corresponding order set, any caveats regarding implementation of the order set, evidence supporting use of the order set, and/or controversial issues regarding use of the order set. Such information may aid a subscriber in determining whether to implement an order set and/or determine why an order set was implemented in the past.

In another aspect of the invention, a computer system for providing medical-related information includes an order set module that stores information regarding a medical order set, and a content module that stores content of a medical information resource. An association module generates a computer-useable record that includes information regarding an association of at least one subscriber of the medical information resource with the order set, and an association of a portion of the order set with content in the medical information resource. A notification module may be provided to notify a subscriber of changes to content in the medical information resource based on the association between a portion of the order set and the content. That is, if changes to content are made, the notification module may detect such changes and their potential effect on an order set, and notify the subscriber accordingly.

In the following discussion, certain illustrative embodiments of an order set establishment and monitoring system are described; however, these descriptions are purely illustrative and are not intended to be limiting. Also, the above and other aspects of the invention will be apparent from the following description. Various aspects of the invention may be used alone or in any suitable combination.

### BRIEF DESCRIPTION OF THE DRAWINGS

Aspects of the invention are described herein with reference to the drawings in which like numerals reference like elements, and wherein:

FIG. 1 shows a schematic diagram of a medical information system 100 in accordance with aspects of the invention;

FIG. 2 shows a sample computer-useable record including order set/content association information; and

FIG. 3 shows a schematic block diagram of an order set and content management system in accordance with aspects of the invention.

### DETAILED DESCRIPTION

Aspects of the invention relate to the maintenance and use of order sets with respect to content in a medical information resource. Although aspects of the invention are not limited to any particular type of medical information resource, illustrative embodiments are described below with reference to a particular medical information resource provided by UpToDate of Waltham, Mass (www.uptodate.com). To provide the reader with context of one such medical information resource, some detail regarding the UpToDate resource is provided below. Thereafter, aspects of the invention relating incorporation of order set management with a medical information resource are described.

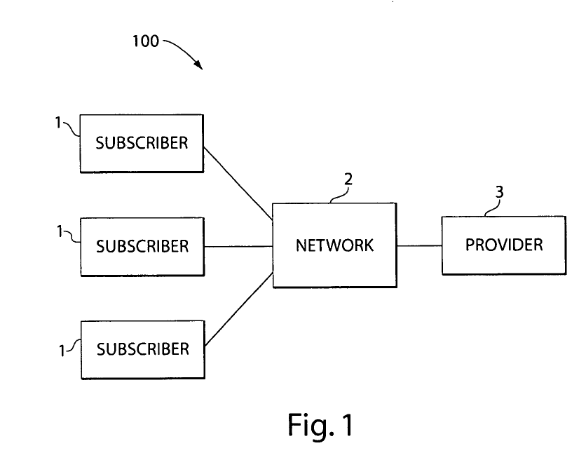

FIG. 1 shows a schematic diagram of a medical information system 100 in accordance with aspects of the invention. Subscribers 1 may have one or more computers that are linked to a network 2, such as the Internet, a telephone network, a local area network (LAN—whether wired or wireless), any other suitable communication network and/or any combination of such networks. (As used herein, a computer includes programmable general purpose computing devices, including laptops, PDAs, electronic writing tablets, network servers, and any other suitable device.) A medical information resource provider 3 may have one or more computers that also communicate with the network 2. Subscribers 1 and the medical information resource provider 3 may exchange information via the network 2. For example, subscribers 1 may access an Internet website or other arrangement maintained by the medical information resource provider 3 to obtain medical information. The website may include a search engine or other interface to allow a user to navigate and locate desired information, such as articles or other content offered by the medical information resource provider 3. One such type of medical information resource provider 3 is UpToDate.

UpToDate: A Clinical Information Resource

The UpToDate medical information resource is an evidence-based clinical information resource available to physicians and designed to provide concise, practical answers to physicians at the point of care. UpToDate's topics are written by trusted experts and are peer-reviewed to ensure that information and recommendations are accurate and reliable.

UpToDate enables physicians to access current information within their specialty, to recognize the clinical manifestations of a wide variety of disorders and describe current options for diagnosis, management and therapy, including the efficacy, doses, and interactions of individual drugs, and to identify optimal screening and prevention strategies. UpToDate's content includes guidelines from a number of major medical societies, as well as reviews of findings published in major medical journals and recommendations made by specialists.

Content within UpToDate's database is organized into topics within specialty areas and may include text, tables, graphics, animations, or information presented in other formats. Within topics, text and other content may be organized into sections and/or paragraphs, such as by diagnosis, treatment, differential diagnosis, pathophysiology, etiology, or other relevant heading. Keywords may be associated with portions of the text, e.g., to enable a user to search for information.

Each topic in the UpToDate database includes a topic review, which provides an overview of information provided within content under the topic. All topic reviews in UpToDate are written by the listed authors in conjunction with a deputy editor. Authors are identified as experts by the Editors-in-Chief, our editorial staff, and the participating societies. Exceptions are guidelines from major societies, which are added to the UpToDate database in original form. All material is originally prepared by the contributing author(s) whose name(s) and affiliation(s) appear in the upper left corner of each topic review. This material is reviewed extensively by physician editors and peer reviewers for accuracy and completeness of the literature search, and for consistency with aspects of the editorial policy. Physician editors suggest changes to ensure that the content under each topic summarizes the relevant evidence, and that the recommendations are consistent with the evidence, with our understanding of patients' values and preferences, and with UpToDate's editorial policy. Some of the content may be taken from other topics in UpToDate. In such cases, the content may be hyperlinked to the topic review from which it originated.

UpToDate follows a hierarchy of evidence consistent with most evidence-based resources. At the top of the hierarchy are randomized trials of high methodological quality, followed by randomized trials with methodological limitations, observational studies, and unsystematic clinical observations. Inferences are stronger when the evidence is summarized in systematic reviews of the literature that present all relevant data.

Each topic has an author who is an expert in the area discussed, and at least two separate physician reviewers. This group works together to perform a comprehensive review of the literature and carefully selects studies for presentation based upon the quality of the study, the hierarchy of evidence discussed above, and clinical relevance. When current, high-quality systematic reviews are available, UpToDate topics and recommendations rely heavily on these reviews. When such reviews are unavailable, UpToDate summarizes the key studies bearing on the clinical issues relating to a topic. Systematic reviews and the design of primary studies (randomized trial, observational studies) are often identified explicitly in the text, with the relevant data. However, in cases where either the type of study or the data are not stated explicitly, users may be allowed to click on the reference and display a Medline abstract or other to obtain this information. Evidence is derived from a number of resources, including but not limited to:

Hand-searching of over 350 peer reviewed journals;

Electronic searching of databases including MEDLINE, The Cochrane Database of systematic reviews, Clinical Evidence, and ACP Journal Club;

Guidelines that adhere to principles of evidence evaluation described above;

Published information regarding clinical trials such as reports from the Food and Drug Administration, as well as other sources of information produced by federal agencies such as the Centers for Disease Control and Prevention and the National Institutes of Health;

Proceedings of major national meetings; and

The clinical experience and observations of our authors, editors, and peer reviewers.

UpToDate's process of arriving at recommendations involves constructing a structured clinical question. That structure includes carefully defining the patient population of interest, the alternative management strategies, and the outcomes of importance to patients. In general, the UpToDate database includes specific recommendations for patient care whenever possible. Recommendations in UpToDate are based upon a synthesis of evidence including that from clinical trials and clinical experience, and whenever possible, the evidentiary basis for recommendations is stated explicitly. When there is no published systematic evidence available (e.g., prednisone dosing regimen in pulmonary sarcoidosis), recommendations are based upon the unsystematic clinical observations of our experts and reviewers, and on pathophysiologic rationale.

UpToDate recommendations identify situations in which different decisions might be appropriate for patients with different values and preferences. Furthermore, UpToDate recognizes that recommendations will not apply to every patient, and counts on clinicians to evaluate the recommendations in light of the individual circumstances of their patient.

In some cases, topics may include a grading of recommendations for treatment and screening. Grades may have two components, a number (1 or 2) reflecting the strength of the recommendation and a letter (A, B, or C) reflecting the quality of the evidence supporting that recommendation. A Grade 1 recommendation is a strong recommendation to do (or not do) something, where the benefits clearly outweigh the risks (or vice versa) for most, if not all patients. A Grade 2 recommendation is a weaker recommendation, where the risks and benefits are more closely balanced or are more uncertain. The majority of recommendations will be grade 2 recommendations. UpToDate uses a wording that reflects the strength of the recommendation: strong (Grade 1) recommendations are “recommended” and weak (Grade 2) recommendations are “suggested”.

Grade A evidence means high-quality evidence that comes from consistent results from well-performed randomized controlled trials, or overwhelming evidence of some other sort (such as well executed observational studies with very strong effects). Grade B evidence means moderate quality evidence from randomized trials that suffer from serious flaws in conduct, inconsistency, indirectness, imprecise estimates, reporting bias, or some combination of these limitations, or from other study designs with special strength. Grade C evidence means low quality evidence from observational evidence, or from controlled trials with several very serious limitations.

The following table presents criteria that UpToDate authors and editors consider when weighing the advantages and disadvantages of treatments to decide on a recommendation, and grade the strength of that recommendation.

| Issue (and considerations) | Recommended process |
|---|---|
| Quality of evidence | Strong recommendations usually require high |
| | quality evidence for all the critical outcomes. The |
| | lower the quality of evidence the less likely |
| | becomes a strong recommendation |
| Relative importance of the outcomes | Authors and editors consider the relative values and |
| (benefits, harms, burdens) | preferences that patients and other stakeholders |
| | place on outcomes and the variability in values and |
| | preferences across patients. If values and |
| | preferences vary widely, a strong recommendation |
| | becomes less likely. |
| Baseline risks of adverse outcomes | The higher the baseline risk of an adverse outcome, |
| (typically most relevant for benefits) | the greater the magnitude of benefit from a |
| | treatment, and the more likely a strong |
| | recommendation. If the baseline risk is very |
| | different for two subpopulations, then UpToDate |
| | may make separate recommendations for these |
| | different populations. |
| Magnitude of effect (benefits - e.g., | Larger relative risk reductions with treatment make |
| reduction in RR; harms - e.g., increase | a strong recommendation for treatment more likely, |
| in RR; burden) | while larger increases in the relative risk of harms |
| | make a strong recommendation for treatment less |
| | likely. |
| Absolute magnitude of the effect | The larger the absolute benefits with treatment, the |
| (benefits, harms, burden) | greater the likelihood of a strong recommendation |
| | in favor of treatment. The larger the absolute |
| | increase in harms, the less likely a strong |
| | recommendation in favor of treatment. |
| Precision of the estimates of the | The greater the precision, the more likely is a |
| effects (benefits, harms and burdens) | strong recommendation |
| Cost | The higher the incremental cost, the less the |
| | likelihood of a strong recommendation in favor of a |
| | treatment. |

UpToDate performs a continuous, comprehensive review of the medical information resource. All of the topic reviews are revised whenever important new information is published, not by any specific time schedule. Updates are integrated carefully, with specific statements as to how the new findings should be applied clinically. Each topic review has a date indicating the most recent time the topic has been reviewed and/or modified. On average, approximately 40 percent of the topic reviews are updated during each four-month cycle. A subset of updates added during each four-month cycle can be viewed by searching on “What's new” and selecting the What's new topic for your area of interest. These represent, according to the editors, the most important new updates added during the previous four months.

The Deputy Editor, the Editor-in-Chief and/or Section Editors assigned to each topic review the entire UpToDate content, including all new topics, updates, and recommendations. In addition, each UpToDate specialty or topic has an assigned group of peer reviewers, often in conjunction with a sponsoring specialty society, who are responsible for reviewing selected topics in each specialty. Also, comments from users are formally addressed with changes made as necessary.

UpToDate and Order Sets

In one aspect of the invention, a medical information resource provider 3, such as the provider of the UpToDate resource in the example above, may create and maintain a medical order sets database that includes a plurality of medical order sets. Each of the medical order sets may be related to a specific medical condition, and may define a comprehensive plan for the specific condition or be confined to a particular aspect of care. Order sets may be used in various settings such as in hospitalized patients, those undergoing elective surgical procedures and those being evaluated during outpatient visits. The specific format of the order set may vary depending upon how it is intended to be used, and the content of an order set may not necessarily be limited directly to the condition for which it has been developed. For example, an order set may contain guidelines to improve the accuracy of billing or compliance with certain quality measures that may not have a direct bearing on the patient condition for which the order set applies. An example of the latter might be the recommendation for vaccination in patients of a certain age even though vaccination may not have a direct bearing on the specific condition for which the order set was designed.

The medical information resource provider 3 may create a portfolio of “typical” or generic order sets that are provided to subscribers 1 via the network 2. The provider 3 may have the understanding that many (if not most) subscribers 1 may modify the order sets to meet their individual requirements. Thus, in this embodiment, the provider 3 may:

Identify a portfolio of order sets that are commonly used (perhaps 250 or so to start for a typical subscriber). Two or three versions of each order set may be provided, as appropriate, such as one for an office-based practice, one for a community hospital, and one for a large medical center. The order sets may be provided in Microsoft Word, XML format, a database file, or some other suitable computer-useable arrangement. Subscribers 1 may be enabled to download or otherwise receive computer useable data that represents the order sets and modify the order sets to meet specific needs as necessary. For example, the subscriber 1 may incorporate all or portions of selected order sets into a patient's electronic medical record.

Provide a topic card for each order set, describing the clinical purpose, any caveats regarding use of the order set, the underlying evidence supporting use of the order set, and/or controversial issues associated with implementing the order set. Each topic card may leverage and refer to other topics as necessary. Subscribers may use the topic cards as a quick reference to determine whether an order set should be used, or if already used, why the order set was selected for use. That is, a subscriber need not necessarily review an entire order set itself to determine the purpose for the order set, but instead may get a sense of the order set's purpose or other issues relating to the order set from the associated topic card. Topic cards may be updated in the same way as topics or other information in the medical information resource are updated, e.g., in response to new evidence, guidelines, and graded recommendations. Subscribers may download or otherwise receive computer data representing the topic cards via the network 2, e.g., the subscribers may view a webpage including topic card information and/or may download a text file for use on the subscriber's computer.

Provide a way for subscribers to receive an “Order Set Alert” service, whereby a subscriber may indicate a desire to receive notification of changes to specific order sets or groups of order sets of interest. Subscribers may receive an email notification or other suitable notice whenever there is a change to any of the order sets identified by the subscriber for change notification. The notification may indicate changes that are relatively minor, such as suggestions for changes to billing procedures, or more important, such as clinically relevant changes. Reasons for the change and/or supporting evidence or other documentation may also be provided to the subscriber.

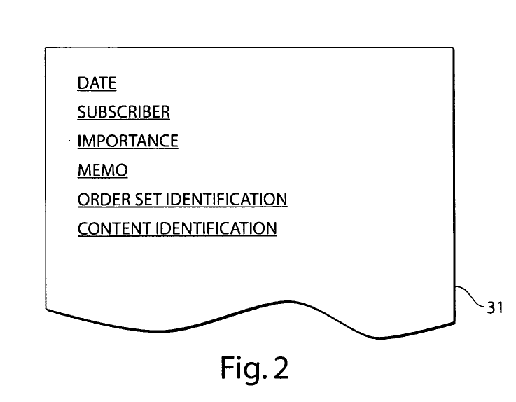

The medical information resource provider 3 may also provide a way for subscribers to register for notification of changes in content of the medical information resource that relate to order sets, including but not limited to order sets topic cards. For users of the “typical” order sets, subscribers may simply identify one or more order sets and the medical information resource provider can identify changes in the content as they relate to one or more portions of the identified order sets. For example, FIG. 2 shows a computer-useable record 31 that may be created by the subscriber 1 or provider 3. The record 31 may be arranged as a graphical user interface that is displayed on a subscriber computer, and various fields of the record 31 completed by the subscriber 1. Although the record 31 may include any suitable fields, in this example, the record includes fields for the date, subscriber identification, importance of the need for notification of changes to the order set and/or content, a memo field that may be used by the subscriber, and an order set identification field that may be used to identify the order set or a portion of the order set for which the subscriber would like to receive notification if changes to related content in the medical information resource occur. In this example where the subscriber 1 uses generic order sets offered by the provider 3, the subscriber 1 may provide needed information including identification of the order set. However, the provider 3 may complete the content identification field to indicate which portions of the content relate to the order set. For example, when generating the order sets, the provider 3 may note those portions of content that relate to order sets, and these associations may be used to complete the subscriber record 31. Alternately, the subscriber may be allowed to supplement the content identification field as desired. Thus, when changes to the content occur, the provider 3 may determine which changes to the content affect which portions of order sets based on records 31, and notify subscribers accordingly. Changes to graded recommendations or other higher-priority content may trigger high priority alerts, whereas lower priority content may trigger lower priority alerts.

For subscriber-modified or subscriber-constructed order sets, subscribers may identify one or more topics, topic cards, blocks of text, tables, and/or other content in the medical information resource that relates to a particular order set, e.g., a portion of the order set. To do so, subscribers may define a computer-useable record like that in FIG. 2 to establish an association between a portion of an order set and content in the medical information resource. As indicated above, the computer-useable record 31 may include information regarding a date of subscription, a responsible party at the subscriber, an importance of the association of the portion of the order set with the content, a memo field, a reference to the portion of the order set, and/or a reference to a portion of the medical information resource. The record may be maintained by the provider 3, and may be accessed by the subscriber 1 to make changes in the record, to review the memo field, e.g., to remind the subscriber why the associated content is of interest, to add other content to the association, and so on. Portions of the content may be identified, for example in the content identification field, at the topic, section, keyword, or paragraph level, e.g., the subscriber may highlight text, tables, media content, and/or other portions of interest in the medical information resource and link the highlighted content to the content identification field. The order set or portion of the order set may be identified in the record 31 by the order set name (or number or other identifier), by hyperlink entered into the record, by a database reference, by computer file address, or other. Thus, the record 31 may be used by a subscriber to associate content in the medical information resource with an order set whether that order set was created by the medical information resource provider, created by the subscriber and/or created by the medical information resource provider and modified by the subscriber.

In another embodiment involving subscriber-created or subscriber-modified order sets, the subscriber may provide the order sets and/or identify changes to “typical” order sets to the provider 3, which may in response identify associations between the modified order set portions and content in the medical information resource 3. Thus, in this embodiment, the provider 3 may create the subscriber record 31 which includes associations between modified portions of an order set and content. As in the embodiment above, the subscriber may review the records as desired and even modify the records, if desired. Notification of changes to content may be provided as suitable.

In another embodiment, subscribers 1 may identify content in the medical information resource and request order set information that relates to the identified content. For example, the subscriber 1 may use the record 31 in FIG. 2 to identify one or more portions of content. Based on this identification, the provider 3 may identify one or more order sets that relate to the identified content, and provide the order set information to the subscriber.

Changes in content may be indicated in any suitable way. For example, editors may flag topics and/or sections of content as containing clinically relevant changes in practice, indicating a level of importance. This may cause email notifications or other notification to subscribers that have order sets associated with the content that has changed. The notification to the subscriber may be indicated, for example, by highlighted text in a topic and/or sections of an article enclosed with an email. The notification may note the before and after state of the paragraph, section, or topic, etc., such as by redlining any additions, deletions, or other changes to the content. For those order sets maintained and used in electronic form, hyperlinks to specific content, or changes to content in text or graphical form, may be inserted into the order set to indicate a change in content. Deleted content may be shown in redline form. The inserted/deleted material may be highlighted to more clearly indicate the presence of a change. In addition, major changes to the underlying content, such as a change in graded recommendations, may trigger an alert in an electronic medical record for a patient, such as a highlight on a fixed hyperlink in the electronic medical record that refers to changed content. Other information regarding the change may be provided, such as the date of the change, the reasons for the change, supporting data or other evidence, etc.

In one embodiment, persistent tags may be placed on content in the medical information resource. For example, UpToDate topics are organized with headings that may be displayed as an outline. Tagging at the outline level may support persistent links to particular sections of content, even if the section is moved among titles. Similarly, particular graphics such as treatment algorithms may be persistently tagged. Thus, for example, portions of an order set may be associated with an outline level topic, and any changes to sections of content that are persistently linked to the outline level topic will cause a notification of change to the order set subscriber.

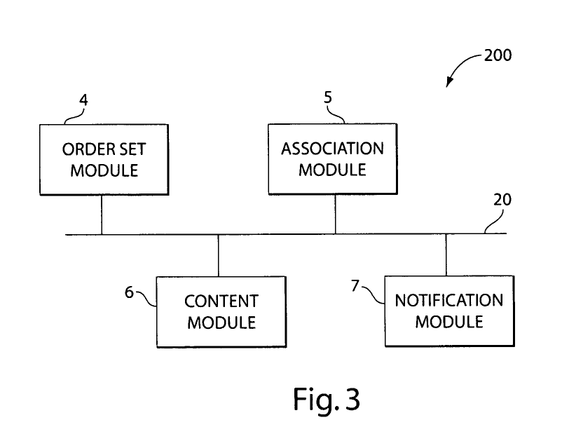

FIG. 3 shows a schematic block diagram of an order set and content management system 200 in accordance with aspects of the invention. The system 200 includes an order set module 4, an association module 5, a content module 6 and a notification module 7. Each of the modules may include suitable computer data storage devices, computer useable data (such as text, graphics or other information in any suitable database, file or other format), communication devices to enable communication within the module and with other modules over a communications link 20 using any suitable communications protocol, data processing devices (such as one or more computer processors), software or other suitable instructions for carrying out the various functions of the module, user input/output devices (such as user pointing devices, a touch screen, printer, computer display, and so on) and/or any other components or devices. The modules 4-7 may be located in a single computer, or may be distributed (either in whole or in part) across multiple devices. Thus, the communications link 20 may include any of the components of the network 2 above, a communications bus internal to a computer, etc., depending on the arrangement of the modules 4-7.

The order set module 4 may store information regarding a plurality of order sets, e.g., in text file, database, XML or other format. In addition, the order set module 4 may store information regarding topic cards for order sets. The order set module 4 may be distributed across a plurality of computers, or implemented on a single computer. For example, the order set module 4 may include order set information stored on a subscriber 1 computer as well as order set information stored on a provider 3 computer. Alternately, for example, the order set module 4 may store only order set information that is generated by a provider 3 on a provider computer.

The content module 6 may store content for a medical information resource, and may include information stored on multiple computers, or on a single machine, such as an Internet server. For example, in one embodiment, users of the medical information resource may access the information in the content module 6 via an Internet webpage. In another embodiment, users may access information in the content module 6 which is stored in a local hard drive, in a storage device accessible by a LAN, or other device at the subscriber location. Access to information in the content module 6 (and/or the order set module 4) may be controlled, e.g., limited only to subscribers to the resource.

The association module 5 receives and stores information regarding associations between order sets and content. For example, if a user indicates the desire to create such an association, the association module 5 may present a graphical user interface that appears like that in FIG. 2 and request that the user complete a record 31 to define the association. The user may be a subscriber 1 (e.g., an employee of a hospital subscriber) or the provider 3 (e.g., an employee of the provider 3) and provide information to complete the record 31. As discussed above, associations may be made by selecting or otherwise inputting a topic, section, paragraph, or other content into the content identification field, and by selecting or otherwise inputting information identifying an order set (e.g., an order set title, number, text and/or address where the order set information can be found). Completion of the order set identification or content identification fields may be automated in some embodiments. For example, if a subscriber is using a provider-generated order set, the subscriber may simply indicate the order set in the order set identification field (e.g., from a computer generated pick list), and the association module 5 may automatically populate the content identification field with content indications that are pre-defined for the order set. Similarly, a subscriber may identify particular content in the content identification field, and the association module 5 may automatically populate the order set identification field with order sets that have been predefined to correspond to the identified content. For example, a subscriber may be reviewing content from the content module 6, and decide to receive order set information relating to the content being reviewed. A link or other interface may be activated by the subscriber, causing the association module 5 to display a graphical user interface for completing a record 31. Identification of the content may be automated, i.e., that content from which the subscriber activated the association module 5. Thereafter, the association module 5 may instruct the order set module 4 to send the related order set information and/or topic card information to the subscriber 1, e.g., so the subscriber can make a determination whether to implement the order sets or not.

In cases where the subscriber is using subscriber-modified order sets and/or subscriber-created order sets, the subscriber may provide the order sets to the association module 5 (via the order set module 4), and in response the association module 5 may generate suitable associations between the order sets (or portions thereof) and content. Associations may be made in an automated fashion, such as by the association module creating associations between order sets and content that share particular keywords or other text, and/or may be created with user input, such as by a user at the provider 3 reviewing the subscriber order sets and creating associations by completing records 31 or another process.

The notification module 7 may operate to provide suitable notification to subscribers, e.g., when changes occur to an order set and/or associated content. For example, when changes occur to content in the content module 6, the notification module 7 may identify what order sets are associated with the changed content (e.g., by analyzing records 31 in the association module) and take steps to provide the desired notification. As discussed above, the notification module 7 may send a notification email, may update order set information in the order set module 4 to indicate the change in associated content (e.g., by inserting changed content text into the order set), and so on. The notification module 7 may also determine whether changes to content require a change in clinical procedure associated with an order set (e.g., based on input from a user that evaluates the content change and indicates to the notification module 7 whether a change in clinical procedure is recommended or not), and notify a subscriber accordingly.

While aspects of the invention have been described in conjunction with specific embodiments thereof, it is evident that many alternatives, modifications, and variations will be apparent to those skilled in the art. Accordingly, embodiments of the invention as set forth herein are intended to be illustrative, not limiting. Various changes may be made without departing from the spirit and scope of the invention.

1. A method for providing medical-related information, comprising:
producing computer-useable data regarding a plurality of medical care order sets, each of the order sets comprising a plurality of tasks to be performed in administering medical care for a patient;
associating at least one subscriber with a first order set in the plurality of order sets;
providing the at least one subscriber, via a computer network, information regarding the first order set for use by the subscriber in administering medical care;
making a change to the first order set based on medical information that is judged to warrant the change in the first order set; and
providing notification to the at least one subscriber via the computer network of the change to the first order set.

2. The method of claim 1, further comprising:
determining if the change to the first order set warrants a corresponding change in clinical procedure; and
providing notification to the at least one subscriber regarding the corresponding change in clinical procedure.

3. The method of claim 1, further comprising:
receiving, via the computer network, information from the at least one subscriber regarding subscriber-made changes to the first order set.

4. The method of claim 3, further comprising:
determining if medical information warrants consideration of a change to the subscriber-made changes to the first order set; and
providing notification to the at least one subscriber regarding the change to the subscriber-made changes.

5. The method of claim 1, further comprising:
associating a portion of the first order set with content in a medical information resource; and
providing notification to the at least one subscriber regarding any changes to the content in the medical information resource that is associated with the portion of the first order set.

6. The method of claim 5, wherein the step of associating comprises:
creating a computer-useable link between the portion of the first order set and the content based on a selected topic, a defined section of the content, a keyword in the content, or a graphical depiction in the content.

7. The method of claim 5, wherein access to the medical information resource is restricted to subscribers to the medical information resource.

8. The method of claim 7, wherein the at least one subscriber is also a subscriber to the medical information resource.

9. The method of claim 1, wherein the medical information is obtained from a medical information resource containing peer-reviewed publications.

10. The method of claim 1, further comprising:
providing a topic card that corresponds to at least one of the order sets, the topic card including a clinical purpose for the corresponding order set, any caveats regarding implementation of the order set, evidence supporting use of the order set, and/or controversial issues regarding use of the order set.

11. A method for providing medical-related information, comprising:
providing information regarding a medical order set, the order set comprising a plurality of tasks to be performed in administering medical care for a patient; and
generating a computer-useable record that includes information regarding an association of at least one subscriber of a computerized medical information resource with the order set, and an association of a portion of the order set with content in the computerized medical information resource.

12. The method of claim 11, further comprising:
providing notification to the at least one subscriber regarding a change to the content in the medical information resource that is associated with the portion of the order set.

13. The method of claim 11, wherein the step of providing includes:
providing to the at least one subscriber, via a computer network, a computer-useable file including information regarding the order set for use in administering medical care;
the method further comprising:
making a change to the order set based on medical information that is judged to warrant the change in the order set; and
providing notification to the at least one subscriber via the computer network of the change to the order set.

14. The method of claim 13, further comprising:
providing a computer-useable link to the associated content in the computer-useable file regarding the order set.

15. The method of claim 14, wherein the computer-useable link is configured to allow a user to select the link and display the associated content.

16. The method of claim 11, wherein the computer-useable record includes information regarding a date of subscription, a responsible party at the subscriber, an importance of the association of the portion of the order set with the content, a memo field, a reference to the portion of the order set, and/or a reference to a portion of the medical information resource.

17. The method of claim 11, further comprising:
providing computer-useable data regarding a topic card that corresponds to at least one order set, the topic card including a clinical purpose for the corresponding order set, any caveats regarding implementation of the order set, evidence supporting use of the order set, and/or controversial issues regarding use of the order set.

18. The method of claim 11, further comprising:
producing computer-useable data regarding a plurality of medical order sets, each of the order sets comprising a plurality of tasks to be performed in administering medical care for a patient; and
wherein the step of providing includes:
providing computer-useable data regarding the order set to the subscriber.

19. The method of claim 11, wherein the step of generating a computer-useable record, comprises:
creating a computer-useable link between the portion of the order set and the content based on a selected topic, a defined section of the content, a keyword in the content, or a graphical depiction in the content.

20. A computer system for providing medical-related information, comprising:
an order set module that stores information regarding a medical order set, the order set comprising a plurality of tasks to be performed in administering medical care for a patient;
a content module that stores content of a medical information resource; and
an association module that generates a computer-useable record that includes information regarding an association of at least one subscriber of the medical information resource with the order set, and an association of a portion of the order set with content in the medical information resource.

21. The system of claim 20, further comprising:
a notification module that notifies a subscriber of changes to content in the medical information resource based on an association between a portion of the order set and the content.

22. The system of claim 20, wherein the computer-useable record includes information regarding a date of subscription, a responsible party at the subscriber, an importance of the association of the portion of the order set with the content, a memo field, a reference to the portion of the order set, and/or a reference to a portion of the medical information resource.

23. The system of claim 20, wherein the order set module further includes computer-useable data regarding a topic card that corresponds to at least one order set, the topic card including a clinical purpose for the corresponding order set, any caveats regarding implementation of the order set, evidence supporting use of the order set, and/or controversial issues regarding use of the order set.
